(19) United States
(12) Patent Application Publication
(10) Pub. No.: US 2002/0111714 A1
(43) Pub. Date: Aug. 15, 2002

(54) Centrifugal evaporator

(76) Inventors: Duncan Guthrie, Nr Sudbury (GB); Graham Broadbent, Old Newton (GB); Roger Lee-Smith, Hadleigh (GB); Michael Cole, Saxmundham (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/123,372

(22) Filed: Apr. 16, 2002

Related U.S. Application Data
(63) Continuation-in-part of application No. 09/341,718, filed on Jul. 15, 1999.

(30) Foreign Application Priority Data
Dec. 23, 1997 (GB) 9727232.2
Dec. 8, 1998 (GB) PCT/GB98/03661
Feb. 2, 2002 (GB) 0202456.0

(51) Int. Cl. G05D 7/00

(52) U.S. Cl. 700/273

(57) ABSTRACT

A method of controlling a centrifugal evaporator in which materials in solution are to be evaporated by rotation in an evacuated evaporation chamber. The method prevents bumping and therefore cross contamination as between one solvent and another in the chamber. Thus prior to centrifuging and reducing the chamber pressure, temperature within the chamber is sensed and a first warning signal is generated if the sensed temperature is greater than a stored temperature value associated with the most volatile solvent component present in the chamber. The first warning signal provides a warning to an operator, and typically inhibits operation of the evaporator. Cooling of the chamber can follow a first warning signal. Data entry means is provided for entering data identifying the solvents in use, and a computer is programmed to compare the entered data with data in a look-up table defining the safe temperatures for different solvents, to identify the safe temperature at which evacuation can begin. The look-up table additionally stores pressure reduction ramp rates and the method involves the selection and utilisation of the particular pressure reduction ramp-rate for the given solvent(s). A rotor speed signal is produced by a sensing device, and compared with a stored speed signal value selected for the solvent or solvents present in the chamber from stored speed values, and the control system is prevented from reducing the chamber pressure below an initial pressure until the rotor speed has achieved the relevant speed.

### FIELD OF THE INVENTION

This invention concerns centrifugal evaporators and a modification thereto which assists in preventing so called “bumping” during evaporation thereby to reduce the unwelcome effects of cross contamination which can occur if bumping is not prevented.

### BACKGROUND

Centrifugal concentration has been known and widely used for several decades as a means for drying solutions and suspensions of compounds or other solids in liquids. Liquids are boiled at reduced pressures at which the boiling point is low enough to prevent thermal decomposition of the solid sample. The creation of a sufficient g force acting down the axis of the sample tubes can prevent bumping. Typically liquids were water or one of a number of simple organic solvents, and laboratory scale equipment has been available for this purpose for many years. It was generally accepted that 150-250 g was sufficient centrifugal force to prevent bumping during evaporation and equipment has generally provided this level of centrifugal force, and has often also provided means for heating the walls of the evaporation chamber to provide the heat required to change a solvent from its liquid phase to its vapour phase (the latent heat of evaporation).

In the mid 1990s many pharmaceutical research laboratories started using mixtures of solvents, and some users complained that they were getting sample loss and cross contamination between test tubes during evaporation when using certain solvent mixes, especially mixtures containing Dichlomethane (DCM) and methanol. Investigation revealed that the inside surface of vacuum chambers in which the samples were being spun were often coated with solid matter and further investigation revealed that this was due to “bumping” caused by a hitherto unknown effect.

Thus with mixtures of a heavy volatile liquid such as DCM (boiling point 40° C. at STP and density 1.22 gm/ml) and a less volatile and lighter liquid such as Methanol (boiling point 80° C. and density 0.8) the liquids were completely miscible and therefore of even composition before application of vacuum. During evaporation, however, the DCM component was evaporated faster than the methanol so that the surface at which the evaporation was taking place became richer in Methanol and therefore lighter (less dense) than the original mixture. This mixture needed either a higher temperature or lower pressure to achieve the original evaporation rate and in practice a lower pressure option was invariably elected. The pressure therefore became considerably lower than that required to boil the original mixture in the bulk of the liquid. This material was, however covered with a layer of less volatile material that prevented the boiling of the bulk liquid so that the bulk liquid became superheated, and as is known the formation of a nucleus in a superheated liquid causes very vigorous boiling which can result in ejection of vapour and liquid through the methanol-rich blanket, often in such a way that it will leave the container tube at high speed.

Bumping in these solvent mixtures can be prevented by the application of a much higher g force in combination with a controlled ramping of the vacuum. It has been found that a force as high as 450 g is necessary. The ramping of the vacuum is necessary to control the superheating of the solvent. The characteristics of the solvent together with its temperature dictate the critical pressure within the chamber. The critical pressure is the minimum pressure at which the higher g force must be achieved and at which the controlled ramping of pressure must start (i.e. the start pressure). The start pressure is therefore defined by the temperature and physical properties of the most volatile component of the solvent mixture.

If a centrifugal evaporator is in operation under conditions where the rotor has been spinning for a few minutes yet the pressure within the chamber and the temperature of the solvent are maintained such that the solvent is not boiling, the temperature of the solvent can be assumed to be close to the mean temperature of the evaporation chamber itself. Measuring the chamber temperature under these conditions will give a good indication of the temperature condition of the solvent. This statement is true because with atmospheric pressure within the chamber together with good mixing of the air due to the spinning of the rotor, the rate of heat transfer between the chamber walls and the sample holders is high. In addition, it is in general a requirement of the design of sample holders for use within modern centrifugal evaporators that there is an efficient transfer of heat between the sample holders and the solvent.

The most volatile solvent in common usage within centrifugal evaporation systems is Dichlomethane (DCM), whose boiling point is 40° C. at STP. If maintained at 20° C., DCM will start to boil at approximately 450 mbar. If maintained at 35° C., DCM will boil at approximately 850 mbar. Clearly from these figures, the “start pressure” is highly sensitive to the solvent temperature, which in turn can be derived from, and is affected by, the chamber temperature.

One possible solution would be to design a centrifugal evaporator so that the “start pressure” is atmospheric pressure. However this would necessitate a motor and drive train capable of maintaining a rotor speed giving a 450 g acceleration in air at atmospheric pressure within the chamber. The pressure ramp would be designed to ramp from atmospheric pressure at a rate of ramp chosen to prevent excessive superheating of the most volatile component of the solvent mixture. This approach generates a number of problems: 1) a very powerful motor and drive train would be required to generate a 450 g acceleration if the chamber pressure is at atmospheric rather than at 500 mbar. Typically the rotor/chamber combination would require a drive train capable of producing more than twice the torque than would be required at 500 mbar. 2) The air resistance generated at atmospheric pressure relative to that generated at 500 mbar will generate significant and unwanted heating of the solvent. This may necessitate cooling of the chamber as is common practice with laboratory centrifuges. 3) Ramping pressure from atmosphere requires approximately twice as long as compared to ramping from a pressure of 500 mbar. This can be very significant. A typical ramp rate is 11 mbar per minute so a ramp from atmospheric pressure would take approximately one and a half hours to complete.

### SUMMARY OF THE INVENTION

According to the present invention in a method of controlling a centrifugal evaporator to prevent bumping and therefore cross contamination, by using a combination of higher accelerations and controlled ramping of pressure, temperature within the chamber is sensed and a warning signal is generated if the sensed temperature is greater than a stored temperature value associated with the most volatile solvent component present in the chamber.

Where the rotor drive train is sized to achieve a rotor speed equivalent to 450 g at a chamber pressure of approximately half an atmosphere, a suitable pressure ramp is one in which the start pressure is not less than the saturated vapour pressure of the most volatile component of the solvent mixture. The temperature signal derived from the evaporating chamber can be used in a variety of ways.

The warning signal may simply provide a warning to an operator (audible or visible) if the sensed temperature is above a safe value given the most volatile solvent component present, but with no inhibition of operation.

Alternatively an interlock may be provided, such that if a warning signal is generated the power may be prevented from reaching the rotor drive motor until the sensed temperature drops below the safe value.

The method may include the step of force-cooling the chamber in the event that a warning signal is generated, whether the drive motor power is inhibited or not. Thus a fan or thermoelectric cooling element may be operated or the chamber may be associated with a cooling coil connected to a refrigeration unit, which is caused to operate if a warning signal is generated.

Preferably a data entry is provided and the method involves the entering of data by an operator, thereby to key in the solvents or mixtures of solvents in use, which are then compared with a look-up table defining safe temperatures for different solvents or solvent mixures, so as to identify the safe temperature at which evacuation can begin for any given solvent or mixture thereof.

In addition to the safe temperatures, the look-up table may store specific ramp rates for specific solvents or solvent mixtures, and the method involves the utilisation of the particular ramp-rate for the given solvent(s).

The rotor drive may be started automatically as soon as the safe temperature is reached, but alternatively, as a safety feature, automatic start-up may be prevented if a warning signal has been generated, and logic may be provided to generate a second, different, warning signal once the sensed temperature has dropped to a “safe” value, to advise an operator that it is now safe to start the centrifuge.

In addition a rotor speed sensing device and a second interlock may be provided, and the method includes the step of generating a rotor speed signal whose value depends on the rotor speed, and the interlock serves to prevent the centrifuge control system from reducing the chamber pressure below the start pressure unless and until the rotor speed has achieved the speed required to achieve a particular g force, typically 450 g.

Where forced cooling and automatic start-up is provided, the invention allows a pre-used and still hot centrifuge to become active once again in minimum time, whilst guaranteeing that no bumping will occur during pressure ramping.

The invention also lies in apparatus for centrifugally evaporating samples comprising solvent mixtures in a temperature controlled vacuum chamber in which means is provided for reducing the chamber pressure below atmospheric in a controlled manner, means is provided to sense temperature within the chamber, and data storage means is provided for storing data relating to at least the safe start temperature of at least the more volatile solvent present in the sample or samples in the chamber, and computer based control means is provided to which signals relating to at least the sensed temperature are supplied and by which signals are generated to control operation of the apparatus which is also adapted to generate a warning signal if the sensed temperature is greater than the safe start temperature stored in the data storage means for the more volatile solvent present.

The apparatus may also include interlock means by which power to the rotor drive is inhibited until the sensed temperature drops below the safe start temperature value provided from the data storage means.

The data storage means may be adapted to store the safe start temperature for each of a plurality of different volatile solvents (or solvent mixtures) and means may be provided for selecting the appropriate solvent from a list of options, so as to provide an appropriate safe start temperature value for determining if the sensed temperature is above or below a safe temperature at which the rotor can be spun and the vacuum ramping can be begun.

The apparatus may include means by which data relating to additional volatile solvents and their safe start temperatures may be entered.

The apparatus may include data entry means by which the various solvents known to be present in any batch of samples can be entered and logic is provided for determining the lowest safe start temperature from the data stored in the apparatus, given the solvents indicated as being present.

The apparatus may include a further interlock which prevents the power from automatically being supplied to the rotor drive if and when the sensed temperature is equal to or below the safe temperature, but instead causes a second warning signal to be generated to advise an operator that the apparatus is now safe to start, so that the supply of power to the rotor is under the control of the operator.

Means for sensing the chamber pressure and rotor speed may also be provided, and the control means is adapted to inhibit pressure reduction of the chamber unless the rotor speed is at least equal to a particular stored value.

The data storage means may also include provision to store other data relevant to the different solvents/solvent mixtures such as the ramp rate for the reduction of pressure in the chamber.

Heating and/or cooling means may be provided, which may be activated during the ramp down process and/or before operation of the rotor drive, to adjust the thermal conditions in the chamber as appropriate and data may be stored in relation to different solvents or solvent mixtures to enable logic to determine if and when operation of the heating and/or cooling means is required.

The interlocks and logic may be performed in software stored in a memory or firmware or a combination of both. Data may be stored in a re-writable memory. Basic operational software may be stored in the same or a separate memory for controlling the operation of the computer based control system which serves to provide control signals, warning signals, and to receive and decode temperature and speed and pressure signals from appropriate sensors associated with the chamber and rotor and/or samples.

If sample temperature can be monitored directly or indirectly, then a signal indicative of sample temperature may be employed as the sensed temperature. Alternatively a signal relating to the chamber temperature may be employed as the sensed temperature. Therefore, references to chamber temperature herein are to be understood to include sample temperature.

Typically the start temperature for typical volatile solvents is in the region of 25° C.

The invention will now be described by way of example with reference to the accompanying drawings in which:

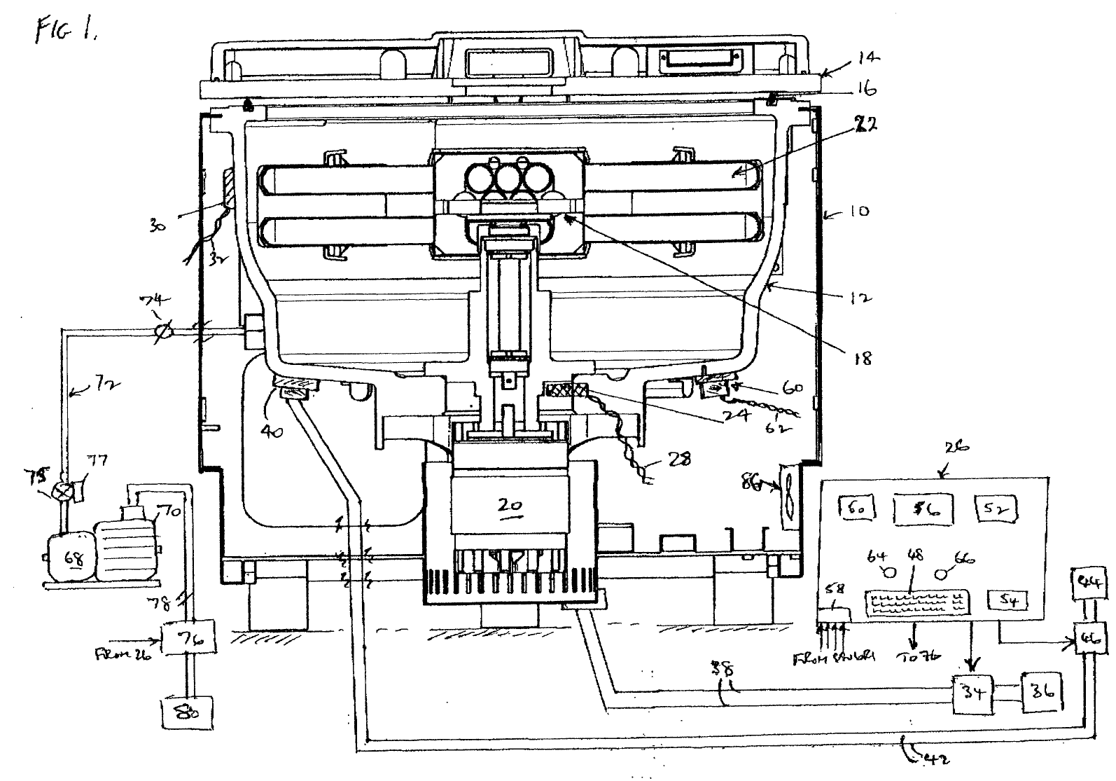

FIG. 1 is a diagrammatic side elevation of an evaporating centrifuge,

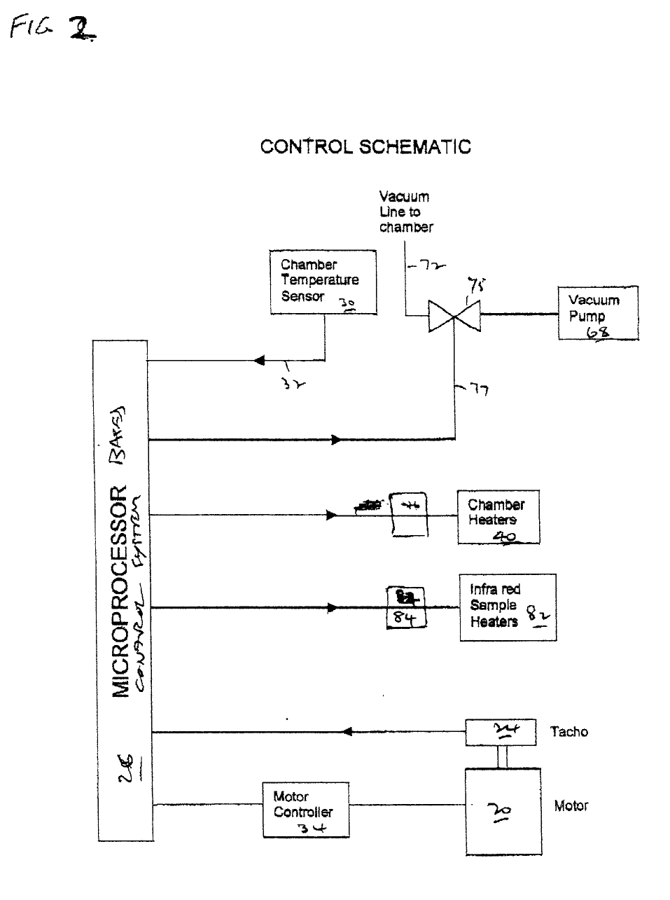

FIG. 2 is a schematic diagram showing how the centrifuge is controlled, and

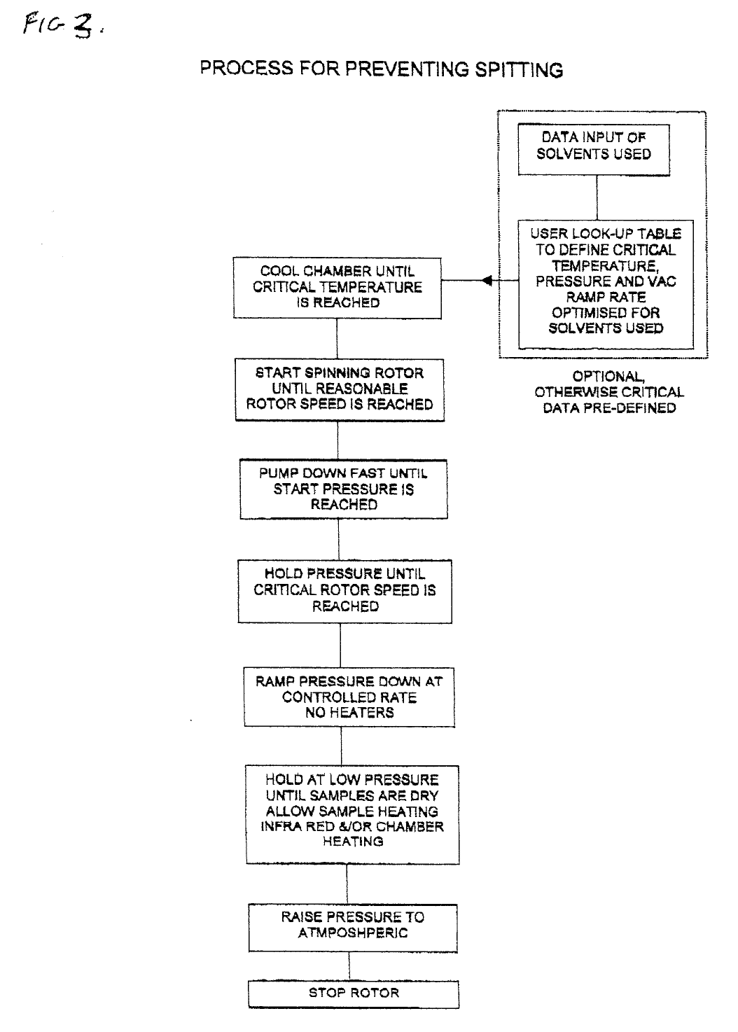

FIG. 3 is a logic schematic showing how the centrifuge is controlled at different points in an evaporation procedure and before the latter can start.

FIG. 1 shows an evaporating centrifuge the important parts of which are the outer casing 10, and a chamber 12 within the casing which is sealable by a lid 14. A seal 16 ensures that air cannot enter or leave the chamber when the lid is closed.

Within the chamber 12 is rotatably mounted a rotor 18 drive for which is provided by an electric motor 20. The rotor carries a number of sample tubes, one of which is denoted by 22, which adopt a horizontal attitude when the rotor spins, but when stationary pivot into an approximately vertical position. Rotation creates a g force on the tubes and their contents, and by mounting the tubes so that their closed ends are outermost when the rotor spins, the g force acting on the liquid contents of the tubes retains the liquid in the tubes near the closed ends thereof.

A tacho 24 provides a speed signal to a computer based control system 26 via an appropriate connection 28 and a temperature sensor 30 provides a temperature signal along a connection 32, also to the control system 26.

Power to the motor 20 is controlled by the control system which controls the opening and closing of a circuit breaker 34 to control the supply of operating current to the motor from a power supply 36 via leads 38.

A heater 40 is provided for heating the chamber and therefore the sample tubes and their contents and power is supplied to the heater along leads 42. Current flow to the heater from a power supply 44 is controlled by a circuit breaker 46, in turn controlled by the control system 26.

Depending on the nature of the heater 40 and temperature sensor 30 thermally conductive windows may be provided in the wall of the chamber for the heater and the sensor.

The control system includes a data entry keyboard 48, a processor 50, memory 52, data carrier receptor 54 such as for example a floppy disc port, CD-reader or port into which a solid state memory device can be plugged. A VDU screen 56 allows data and/or status to be displayed to an operator such as indications of operating status, speed, temperature, vacuum pressure (within the chamber), evaporation program (if different programs are available), time to end of current program, solvent(s) in the sample tubes in the current program (in accordance with what has been entered by the operator) and an indication of any fault or hazard conditions and the like.

A suitable interface 58 is provided for digitising the signals from the sensors and in order to provide a measure of chamber pressure a pressure sensor such as 60 is provided and pressure signals are supplied via a connection 62. The signals from the sensors are therefore supplied to the control system bus via the interface 58.

A basic software operating system is loaded into the memory 52 to control the operation of the processor 50 and the transfer of data to and from the bus in a conventional manner. A different part of the memory serves to store semi-permanent data in the form of a look-up table to allow an appropriate program to be selected from memory depending on the data input into the system by the operator via the keyboard 48 such as what solvent(s) is/are present.

When the control system has been appropriately programmed, the samples loaded and the lid closed on the chamber an evaporation process is initiated by keying in appropriate instructions using the keyboard or if provided, by pressing a start button 64.

A software interlock prevents the control system from supplying current to operate (close) the circuit breaker 34 if the temperature signal is above a threshold value determined by the selected program and the solvent(s) present.

An emergency shut down button 66 allows the operator to remove power from the centrifuge and apply emergency braking if provided (not shown), if the operator senses that something is seriously wrong.

The pressure in the chamber is controlled by a vacuum pump 68 driven by its own electric motor 70 and connected to the chamber via a pipe 72. A valve 74 is provided to allow chamber pressure to be restored to atmospheric and a solenoid valve 75, also controlled by signals from 26 via lead 77, is provided to control the application of vacuum to the chamber. Power to the vacuum pump motor 70 is supplied via a circuit breaker 76 and leads 78 from a power supply 80 and the circuit breaker 76 is opened and closed by signals from the control system 26.

Although not shown infra red sample heaters may be located in the chamber walls to direct heat directly to the base of each of the sample tubes such as 22 as they rotate. The supply of power to the infra red heaters is controlled by a controller (not shown in FIG. 1) but denoted by 84 in FIG. 2.

A fan 86 may be provided to direct cooling air onto the chamber to cool the latter, so that if the temperature of the chamber sensed by 30 is too high (above a critical value to allow a program to begin) the fan is operated by a signal from the control system 26 until the temperature within the chamber has dropped below the critical value.

FIG. 2 is a simplified schematic of the control system where the same reference numerals as have been employed in FIG. 1 denote those parts of the system of FIG. 1 shown in FIG. 2. The infra red heaters, not shown in FIG. 1, are denoted in FIG. 2 by reference numeral 82, and their controller by reference numeral 84.

The software logic/control commands/data input requirements are shown in FIG. 3.

Although not shown a temperature sensor may be mounted on the rotor adapted to sense the temperature of at least one of the sample tubes and means is provided for transmitting a signal to a stationary receiver whose value is proportional to the sensed temperature of the sample tube, for providing a sample temperature signal to the control system interface 58.

1. A method of controlling a centrifugal evaporator in which materials in solution are to be evaporated by rotation by a rotor driven by a drive motor in an evacuated evaporation chamber, so as to prevent bumping and therefore cross contamination as between one solvent and another in the evaporation chamber, wherein prior to centrifuging and reducing the chamber pressure, temperature within the chamber is sensed and a first warning signal is generated if the sensed temperature is greater than a stored temperature value.

2. A method according to claim 1 wherein the stored temperature value is associated with the most volatile solvent component present in the chamber.

3. A method according to claim 1 wherein the first warning signal provides an audible or visible warning to an operator if the sensed temperature is above the stored value.

4. A method according to claim 1 wherein the first warning signal inhibits operation of the evaporator.

5. A method according to claim 1 wherein an interlock is provided, such that if a first warning signal is generated power is prevented from reaching at least the rotor drive motor until the sensed temperature drops below the stored value.

6. A method according to any of claim 1 further comprising the step of cooling the chamber in the event that a first warning signal is generated.

7. A method according to claim 1 wherein computer means including a look-up table memory containing safe temperatures for different solvents or solvent mixtures and data entry means is provided and the method involves the steps of entering data identifying the solvent or solvents in use, and wherein the computer is programmed to compare the entered data with data in the look-up table defining the safe temperatures for different solvents or mixtures, thereby to identify the safe temperature at which evacuation can begin for any given solvent or mixture of solvents, the safe temperature comprising the said stored temperature.

8. A method according to claim 7 wherein the look-up table additionally stores pressure reduction ramp rates for specific solvents or solvent mixtures, and the method involves the selection and utilisation of the particular pressure reduction ramp-rate for the given solvent(s).

9. A method according to claim 4 wherein the chamber rotor drive motor is started automatically as soon as the sensed temperature reaches the stored temperature.

10. A method according to claim 7 wherein the computer means is further programmed to generate a second warning signal which is generated after the first warning signal has been generated, but only after the sensed temperature has dropped to the stored value, and the second warning signal is adapted to advise an operator that it is now safe to start the centrifugal evaporation process.

11. A method according to claim 7 wherein a rotor speed sensing device and a second interlock are provided, and speed signal values are also stored for different solvents in the look up table and the method includes the steps of generating a rotor speed signal by the speed sensing device whose value depends on the rotor speed of rotation, and comparing the generated speed signal value with the stored value relating to the solvent or solvents present in the chamber, and the second interlock serves to prevent the centrifugal evaporator control system from reducing the chamber pressure below an initial pressure until the rotor speed signal value has achieved the relevant stored speed signal value.

12. A method according to claim 11 wherein liquid material is stored in at least one holder on the rotor, and the stored speed values correspond to rotor speeds which are required to generate a particular g force on liquid carried by a holder on the rotor.

13. A method according to claim 12 wherein the g force is 450 g.

14. A method according to claim 8 wherein the selected pressure reduction ramp is one in which the start pressure is not less than the saturated vapour pressure of the most volatile component of the solvent mixture.

15. Apparatus for centrifugally evaporating liquid sample material comprising solvent mixtures carried by a rotor rotatable by a rotor drive means in a temperature controlled vacuum chamber in which means is provided for reducing the chamber pressure below atmospheric in a controlled manner, means is provided to sense temperature within the chamber, data storage means is provided for storing data in the form of a look-up table relating to at least a safe start temperature for a plurality of solvents or solvent mixtures, data entry means is provided for entering information as to the solvent or solvents present in sample material to be evaporated in the chamber, and computer based control means is provided to which the information on the solvent or solvents present and signals relating to at least the sensed temperature are supplied and by which signals are generated with reference to the look-up table to control operation of the apparatus, which computer based control means is adapted to identify from the stored data the safe start temperature and is further adapted to generate a first warning signal if the sensed temperature is greater than the identified safe start temperature.

16. Apparatus according to claim 15 wherein the rotor drive means is selected so as to achieve a rotor speed which will generate a force of 450 g at a chamber pressure of approximately half an atmosphere.

17. Apparatus according to claim 15 further comprising interlock means by which power to the rotor drive means is inhibited until the sensed r temperature reaches the safe start temperature.

18. Apparatus according to claim 15 wherein the data entry means is also adapted to allow data to be entered relating to volatile solvents or solvent mixtures and their safe start temperatures, thereby to build up the look-up table.

19. Apparatus according to claim 15 further comprising a visual display device for displaying information to a user, and wherein the control means is also adapted to display a list of solvents or solvent mixtures and means is provided by which a user can select one of the displayed solvents or mixtures thereof, and the control means derives a safe start temperature value from the look-up table.

20. Apparatus according to claim 15 wherein the data entry means is adapted to enable information identifying a mixture of solvents known to be present in sample material to be entered, and logic means is provided adapted to determine the lowest safe start temperature from the look-up table, for the solvents indicated as being present.

21. Apparatus according to claim 15 which further comprises an interlock which prevents the power from being supplied to the rotor drive means if a first warning signal is generated even when the sensed temperature reaches the safe start temperature.

22. Apparatus according to claim 21 wherein the control means generates a second warning signal to advise an operator that the apparatus is now safe to start, so that the supply of power to the rotor drive means is under the control of the operator.

23. Apparatus according to claim 15 further comprising means for storing rotor speed signals, the values of which correspond to different rotor speeds required to generate particular g forces on sample material on the rotor, as a part of the look-up table.

24. Apparatus according to claim 23 further comprising means for sensing rotor speed to generate a rotor speed signal the value of which is proportional to the rotor speed and the control means is adapted to inhibit reduction of the chamber pressure unless the rotor speed signal is at least equal to a particular stored value of rotor speed for the sample material present.

25. Apparatus according to claim 15 wherein the data storage means also includes means to store the rate at which chamber pressure should be reduced for different solvents/solvent mixtures, and ramp rate values are stored therein in the form of a look-up table.

26. Apparatus according to claim 15 further comprising chamber temperature controlling means for heating and/or cooling the chamber and the control means is adapted to activate the temperature controlling means to adjust the thermal conditions in the chamber before and/or during ramp down of pressure.

27. Apparatus according to claim 26 wherein the temperature controlling means is a fan, or a thermoelectric cooling element, or a cooling coil connected to a refrigeration unit, which is caused to operate if a warning signal is generated.

28. Apparatus according to claim 26 wherein the data storage means is adapted to store data relating to the desired temperature sensed in the chamber for different points in the evaporation process as a look-up table depending on the solvent or solvents present, and the control means is adapted to monitor the sensed temperature and to determine if and when operation of the temperature controlling means is required.

29. Apparatus according to claim 15 wherein the data entry means is adapted to enable information identifying a mixture of solvents known to be present in sample material to be entered, and logic means is provided adapted to determine the lowest safe start temperature from the look-up table, for the solvents indicated as being present, and which further comprises an interlock which prevents the power from being supplied to the rotor drive means if a first warning signal is generated even when the sensed temperature reaches the safe start temperature, and the comparisons, interlocks and logic are performed in software stored in a memory or in firmware or a combination of both.

30. Apparatus according to claim 15 wherein the data storage means is a re-writable memory.

31. Apparatus according to claim 30 wherein basic operating software for the computer based control means is stored in a separate memory.

32. Apparatus according to claim 31 wherein during operation the basic operating software serves to provide control signals, warning signals, and to receive from and decode temperature and speed and pressure signals associated with the chamber and/or rotor and/or samples.

33. Apparatus according to claim 15 wherein the temperature sensing means senses the temperature within the chamber.

34. Apparatus according to claim 15 wherein the temperature sensing means senses sample temperature and a signal indicative of sample temperature.

35. Apparatus according to claim 15 wherein the safe start temperature is in the region of 25° C.
